(19) United States
(12) Patent Application Publication
(10) Pub. No.: US 2013/0154959 A1
(43) Pub. Date: Jun. 20, 2013

(54) SYSTEM AND METHOD FOR CONTROLLING AN ELECTRONIC DEVICE

(71) Applicants: Donald James LINDSAY, Mountain View, CA (US); Laura MAHAN, Kanata (CA); Roy Robert George WILSON, Stittsville (CA)

(72) Inventors: Donald James LINDSAY, Mountain View, CA (US); Laura MAHAN, Kanata (CA); Roy Robert George WILSON, Stittsville (CA)

(73) Assignee: RESEARCH IN MOTION LIMITED, Waterloo (CA)

(21) Appl. No.: 13/332,180

(22) Filed: Dec. 20, 2011

(51) Int. Cl. G06F 3/041

(52) U.S. Cl. 345/173

(57) ABSTRACT

A method and system are provided for controlling an electronic device. The method includes detecting a gesture on a touch-sensitive input mechanism of the electronic device, the gesture comprising an origin point and an end point, and executing a command associated with the gesture, the command comprising a back command if the end point is located left of the origin point with respect to an orientation of the electronic device or comprising a forward command if the end point is located right of the origin point with respect to the orientation of the electronic device, wherein a dedicated non-gesture input mechanism to input the command is absent from the electronic device.

### TECHNICAL FIELD

The following relates generally to controlling an electronic device using a gesture.

### DESCRIPTION OF THE RELATED ART

Many electronic devices, including mobile devices, include one or more touch-sensitive input mechanisms such as a touch-sensitive display or a touch pad to provide inputs to the electronic device. The user can provide an input to the touch-sensitive component using an object (e.g. a finger of a user or a stylus) to perform a gesture near or directly on the surface of the touch-sensitive component. For example, the gesture can include swiping the object upwards or downwards across a portion of the touch-sensitive display to scroll content displayed on the touch-sensitive display. Other gestures can include more than one object (e.g. two fingers of a user). For example, a gesture can include placing two objects on a touch-sensitive display and bringing the objects closer together to perform a “pinching” gesture to zoom into content displayed on the touch-sensitive display.

### BRIEF DESCRIPTION OF THE DRAWINGS

Embodiments will now be described by way of example only with reference to the appended drawings wherein:

FIG. 1 is a plan view of an example embodiment of a mobile device receiving a gesture.

FIG. 2 is a plan view of an example embodiment of a mobile having dedicated buttons.

FIG. 3 is a plan view of a touch-sensitive display showing a normal view having dedicated back and forward soft buttons.

FIG. 4 is a plan view of the touch-sensitive display of FIG. 3 showing a full screen view without visible buttons.

FIG. 5 is a block diagram of an example of a wireless communication system.

FIG. 6 is a block diagram of an example of a mobile device.

FIG. 7 is a plan view of an example of a mobile device.

FIG. 8 is a plan view of another example of a mobile device.

FIG. 9 is a plan view of example gestures on the mobile device of FIG. 8.

FIG. 10 is a block diagram of an example configuration of a gesture input application.

FIG. 11 is a flow diagram of example computer executable instructions for controlling a mobile device using a gesture.

FIG. 12 is a plan view of an example embodiment of a mobile device receiving gestures.

FIG. 13 is a plan view of another example embodiment of a mobile device.

FIG. 14 is a flow diagram of example computer executable instructions for implementing a calibration routine.

FIG. 15 is a plan view of another example embodiment of a mobile device receiving gestures.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

Recently, electronic devices, including tablet computers and other mobile devices, may include a touch-sensitive input mechanism, such as a touch-sensitive display, in replacement of other non touch-sensitive input mechanisms that have previously been used. Furthermore, even if other non touch-sensitive input mechanisms are provided, a user may prefer to use a touch-sensitive input mechanism as a user may find gestures more natural, intuitive and easier to carry out.

Therefore, touch-sensitive input mechanisms may provide functionality previously associated with other non touch-sensitive input mechanisms. For example, one or more physical buttons typically found on some electronic devices may be absent from other electronic devices having a touch-sensitive display. One of such buttons may be a dedicated “back” button associated with a back command. In one example, a touch-sensitive display can provide the ability to input a back command by displaying a virtual (i.e. on-screen) “back” button on the touch-sensitive display. However, a virtual button takes space on the touch-sensitive display that could be used to display other content.

It has been recognized that methods for inputting a back command on an electronic device are limited. To address this, the following describes a method, computer readable storage medium and mobile device operable to control an electronic device.

In one aspect there is provided a method of controlling an electronic device. The method comprising: detecting a gesture on a touch-sensitive input mechanism of the electronic device, the gesture comprising an origin point and an end point, and executing a command associated with the gesture, the command comprising a back command if the end point is located left of the origin point with respect to an orientation of the electronic device or comprising a forward command if the end point is located right of the origin point with respect to the orientation of the electronic device. A dedicated non-gesture input mechanism to input the command is absent from the electronic device.

In another aspect, there is provided a computer readable storage medium for controlling an electronic device. The computer readable storage medium comprising computer executable instructions for: detecting a gesture on a touch-sensitive input mechanism of the electronic device, the gesture comprising an origin point and an end point, and executing a command associated with the gesture, the command comprising a back command if the end point is located left of the origin point with respect to an orientation of the electronic device or comprising a forward command if the end point is located right of the origin point with respect to the orientation of the electronic device. A dedicated non-gesture input mechanism to input the command is absent from the electronic device.

In another aspect, there is provided an electronic device comprising a processor, a touch-sensitive input mechanism and memory, the memory storing computer executable instructions for: detecting a gesture on the touch-sensitive input mechanism, the gesture comprising an origin point and an end point, and executing a command associated with the gesture, the command comprising a back command if the end point is located left of the origin point with respect to an orientation of the electronic device or comprising a forward command if the end point is located right of the origin point with respect to the orientation of the electronic device. A dedicated non-gesture input mechanism to input the command is absent from the electronic device.

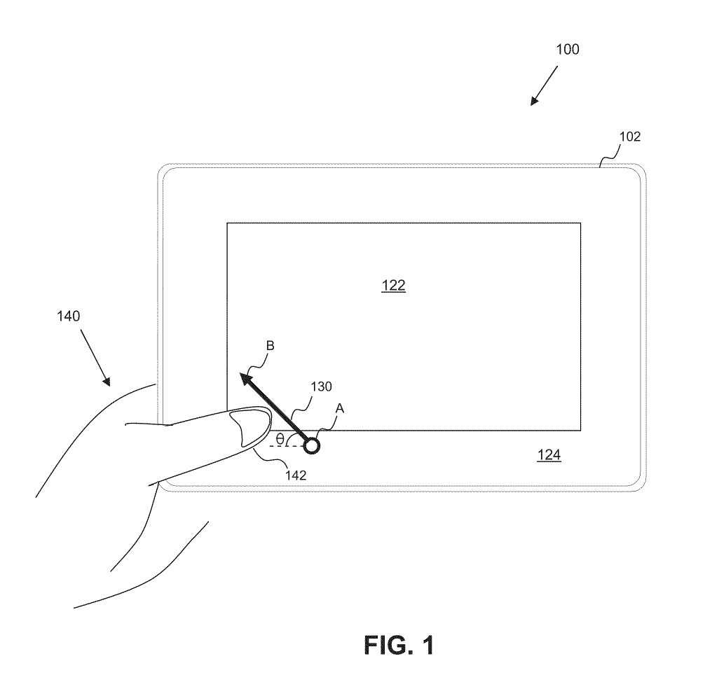

Referring to FIG. 1, a plan view of an example embodiment of an electronic device, such as a mobile device 100, receiving a gesture 130 is provided. The mobile device 100 includes a touch-sensitive display 102. The touch-sensitive display 102 includes a touch-sensitive non-display area 124 surrounding a touch-sensitive display area 122, both of which may be capable of receiving inputs in the form of gestures. The gesture 130 may involve the touch-sensitive non-display area 124, the touch-sensitive display area 122, or both.

The gesture 130 shown in FIG. 1 is an example of a back gesture. A back gesture refers to a gesture that has an origin point A and an end point B where the end point B is to the left of the origin point A. As the notion of “forward” may be associated with the movement from left to right, a gesture that includes a swiping motion from right to left may intuitively be associated with the notion of “back” and thus may be a suitable gesture to be associated with a back command.

The gesture 130 of FIG. 1 comprises a swiping motion in a diagonally upward/left direction with respect to the orientation of the mobile device, and is at an angle θ with respect to an axis parallel to the length of the mobile device 100. A gesture moving in a diagonally upward and left direction may be performed by a user holding the mobile device 100 with his/her left hand 140 by moving the left thumb 142 through its natural motion, (i.e. rotating about the base of the thumb to move the end of the thumb simultaneously upwards and left or simultaneously downwards and right). Furthermore, a user may not need to release hold of the mobile device 100 with the left hand 140 to perform the gesture 130 as the thumb 142 may already be suitable placed near or over the touch-sensitive display 102. This may allow diagonal gestures, such as the gesture 130, to be performed quickly, comfortably and ergonomically, which may make them well suited for inputting frequent commands such as the back command.

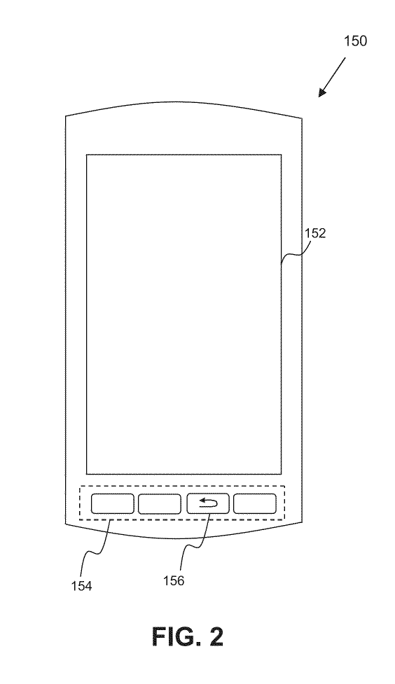

The example mobile device 100 of FIG. 1 does not have a physical button associated with a back command. In contrast, another example mobile device 150 shown in FIG. 2 includes a display 152 and one or more physical buttons 154 on the housing of the mobile device 150, including a dedicated back button 156 for inputting a back command. In another example, the dedicated back button may be a virtual on-screen button displayed on a touch-sensitive display 152.

The other mobile device 150 or a program running on it may be developed for a different platform than the mobile device 100. For example, a program, such as an operating system or other software application, running on the other mobile device 150 may be designed for mobile devices having a dedicated back button 156 or other input mechanism not available on the mobile device 100. Examples of other input mechanisms may be voice commands, a trackball, mouse or trackpad, physical gestures/commands captured by a video, etc.

However, the input requirements of a program designed for the other mobile device 150 can be provided by the mobile device 100 by configuring the mobile device 100 to associate a command inputted by an input mechanism of the mobile device 150 with the gesture 130 performed on the mobile device 100. This enables a program designed for the other mobile device 150 to be ported over and run on the mobile device 100. For example, instead of using an input mechanism provided by the other mobile device 150, such as pressing the back button 156 to input a back command, a gesture 130 can be performed on the touch-sensitive display 102 of the mobile device 100.

In an example embodiment, a command, such as a back command, may be associated only with a set of gestures 130 satisfying predetermined criteria. For example, the predetermined criteria may include being an upward/left diagonal swipe gesture elevated at an angle θ within a predetermined range. As a result, the back command can only be inputted by performing such a gesture 130 on the mobile device 100. This will enable the mobile device 100 to operate without providing another input mechanism, such as a dedicated button, to input the back command. Absence of other input mechanisms, such as dedicated buttons, can simplify the design of the mobile device 100, reduce hardware complexity and/or improve its physical appearance. Furthermore, a user may prefer a gesture over other input mechanisms because a gesture may feel more natural, intuitive and/or easier to carry out.

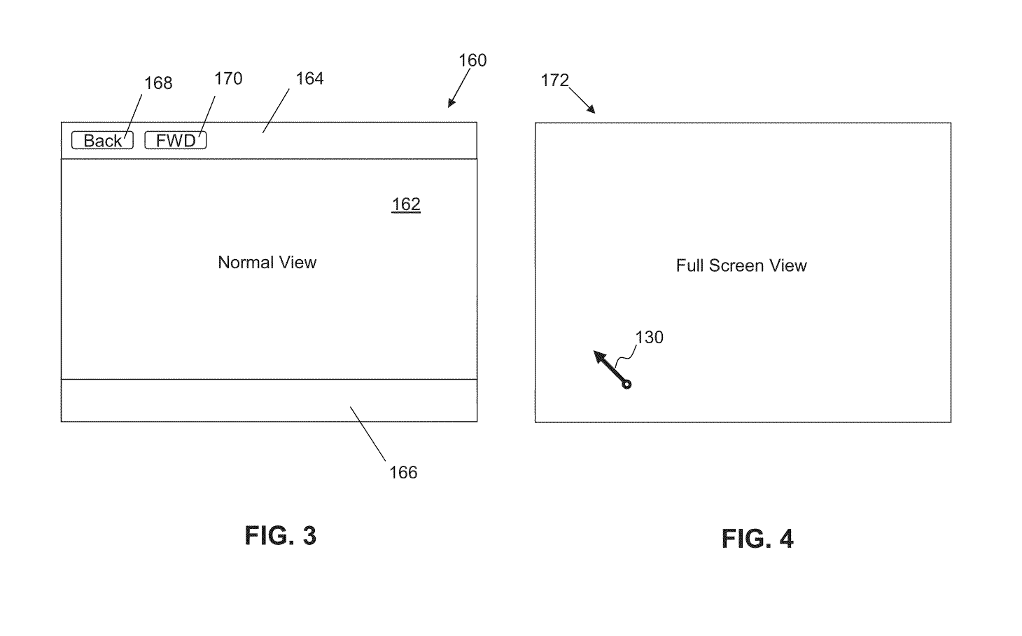

It can be appreciated that dedicated virtual or “soft” buttons may be visible in one view of an application but not in another view. For example, as shown in FIG. 3, a normal view 160 on a touch-sensitive display includes an application content portion 162, a banner portion 164, and a task bar 166. When a display is segmented in the way shown illustratively in FIG. 3, dedicated soft buttons (or other on-screen controls) can be readily incorporated into what is being displayed. In the example shown in FIG. 3, a dedicated back button 168 and a dedicated forward (FWD) button 170 are incorporated into the banner portion 164. This allows a user to control content being viewed in the content portion 162 without requiring menus or other input mechanisms. For example, the content portion 162 may include a slideshow of photos wherein the back button 168 and forward button 170 are used to go back and advance, respectively, in a sequence of photos. Similarly, the banner portion 164 or task bar 166 could be configured to include controls for a media player, a web browser and various other types of applications. In another example (not shown), the soft buttons 168 and 170 are displayed on the content portion 162 of the touch sensitive display.

A touch-sensitive gesture, such as gesture 130, that is mapped to a particular command can advantageously be used in scenarios when soft buttons (or other on-screen controls) that are normally displayed (or otherwise available), such as those shown in FIG. 3, are not displayed in other views. For example, FIG. 4 illustrates an example of a full screen view 172 which expands the content in the content portion 162 in the normal view 160 to utilize the entire screen. In such cases, the back button 168 and forward button 170 may be removed from the display as shown to maximize a viewing area. By enabling the gesture 130 to be utilized in the full screen view 172, particular commands that are available in one view can be provided in another view without disrupting the intended display layout in the other view. In the example shown in FIGS. 3 and 4, controls and other inputs that are displayed in the normal view 160 can be swapped for gesture-based commands in the full screen view 172 to balance the competing objectives of functionality and maximizing viewing area.

It can therefore be seen that the back command can be inputted by performing a gesture 130 on the touch-sensitive display 102 of a mobile device 100. As will be discussed, the mobile device 100 can be configured to associate the gesture 130 with a command in various ways.

Examples of applicable mobile electronic devices may include, without limitation, cellular phones, smart-phones, tablet computers, wireless organizers, personal digital assistants, computers, laptops, handheld wireless communication devices, wirelessly enabled notebook computers, portable gaming devices, and the like. Such devices will hereinafter be commonly referred to as “mobile devices” 100 for the sake of clarity. It will however be appreciated that the principles described herein are also suitable to other electronic devices, e.g. “non-mobile” devices. For example, the principles herein are equally applicable to personal computers (PCs), tabletop computing devices, wall-mounted screens such as kiosks, or any other computing device.

The mobile device 100 may be a two-way communication device with advanced data communication capabilities including the capability to communicate with other mobile devices or computer systems through a network of transceiver stations. The mobile device may also have the capability to allow voice communication. Depending on the functionality provided by the mobile device, it may be referred to as a data messaging device, a two-way pager, a cellular telephone with data messaging capabilities, a wireless Internet appliance, or a data communication device (with or without telephony capabilities).

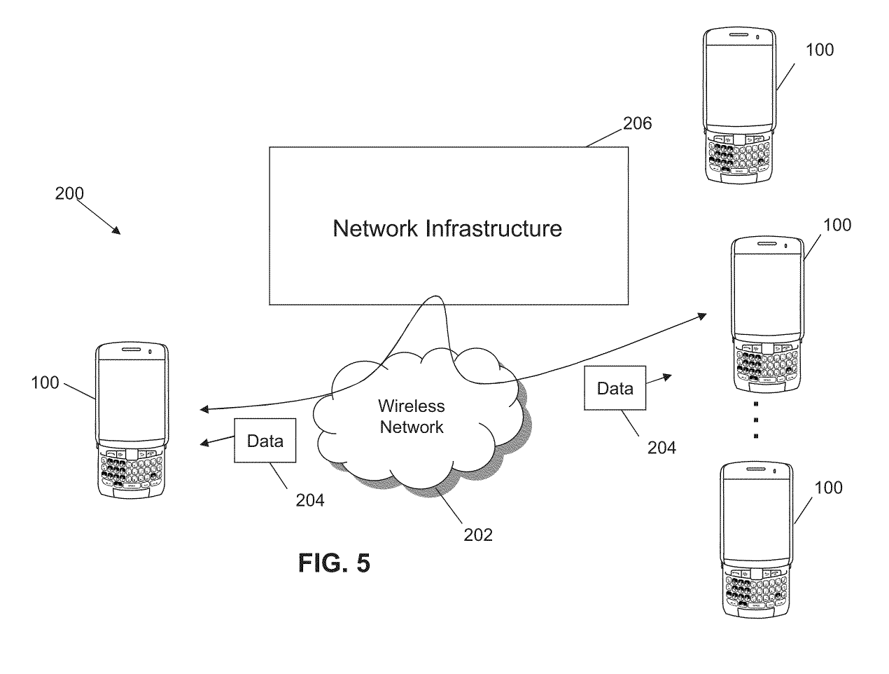

Referring to FIG. 5, an example communication system 200 is shown. The communication system 200, in this example, enables, at least in part, mobile devices 100 to communicate with each other via a wireless network 202. For example, as shown, data 204 may be exchanged between various mobile devices 100. Data 204 that is sent from one mobile device 100 to another mobile device 100 may be transmitted according to a particular messaging or communication medium, protocol, or other mechanism. For example, as shown in FIG. 5, data 204 may be sent over the wireless network 202 via a component of a network infrastructure 206. The network infrastructure 206 can include various systems that may be used by the mobile devices 100 to exchange data 204. For example, a peer-to-peer (P2P) system, a short message service centre (SMSC), an email system (e.g. web-based, enterprise based, or otherwise), a web system (e.g. hosting a website or web service), a host system (e.g. enterprise server), and social networking system may be provided by or within or be otherwise supported or facilitated by the network infrastructure 206. The mobile devices 100 may therefore send data to or receive data from other mobile devices 100 via one or more particular systems with which the mobile devices 100 are communicable via the wireless network 202 and network infrastructure 206.

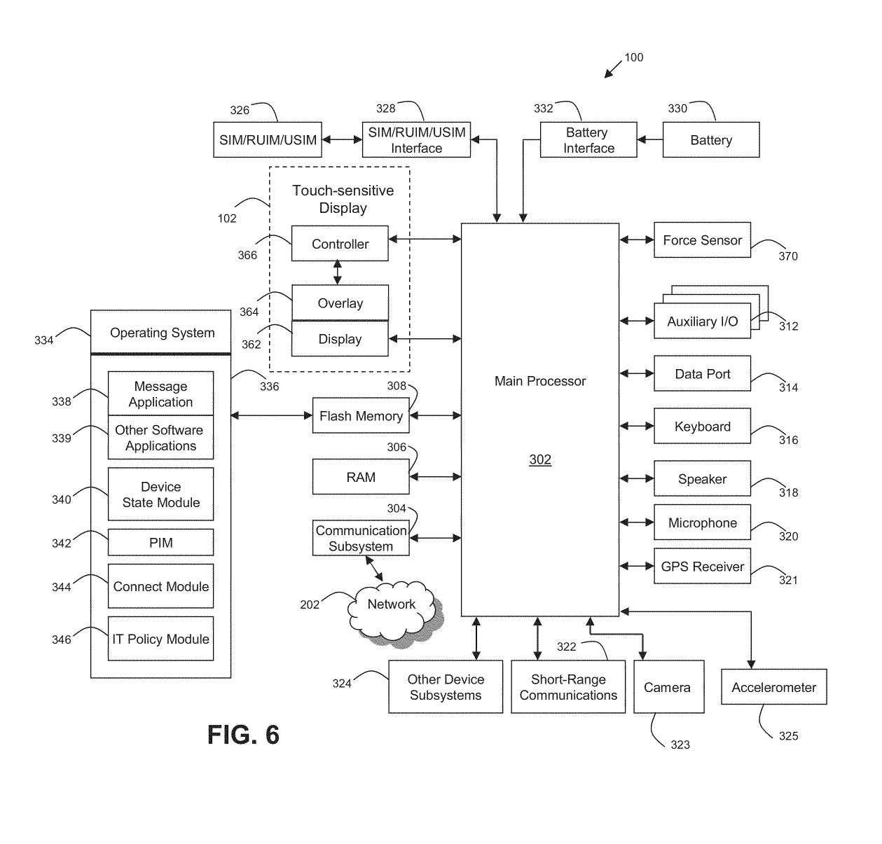

Referring to FIG. 6, a block diagram is provided to aid the reader in understanding an example configuration of a mobile device 100. The mobile device 100 includes a number of components such as a main processor 302 that controls the overall operation of the mobile device 100. Communication functions, including data and voice communications, are performed through a communication subsystem 304. The communication subsystem 304 receives messages from and sends messages to a wireless network 202. In this example of the mobile device 100, the communication subsystem 304 is configured in accordance with the Global System for Mobile Communication (GSM) and General Packet Radio Services (GPRS) standards, which is used worldwide. Other communication configurations that are equally applicable are the 3G and 4G networks such as Enhanced Data-rates for Global Evolution (EDGE), Universal Mobile Telecommunications System (UMTS) and High-Speed Downlink Packet Access (HSDPA), Long Term Evolution (LTE), Worldwide Interoperability for Microwave Access (Wi-Max), etc. New standards are still being defined, but it is believed that they will have similarities to the network behaviour described herein, and it will also be understood by persons skilled in the art that the example described herein are intended to use any other suitable standards that are developed in the future. The wireless link connecting the communication subsystem 304 with the wireless network 202 represents one or more different Radio Frequency (RF) channels, operating according to defined protocols specified for GSM/GPRS communications.

The main processor 302 also interacts with additional subsystems such as a Random Access Memory (RAM) 306, a flash memory 308, a touch-sensitive display 102, an auxiliary input/output (I/O) subsystem 312, a data port 314, a keyboard 316, a speaker 318, a microphone 320, a GPS receiver 321, short-range communications 322, a camera 323, a accelerometer 325 and other device subsystems 324. Some of the subsystems of the mobile device 100 perform communication-related functions, whereas other subsystems may provide “resident” or on-device functions. By way of example, the display 102 and the keyboard 316 may be used for both communication-related functions, such as entering a text message for transmission over the network 202, and device-resident functions such as a calculator or task list. In one example, the mobile device 100 can include a non touch-sensitive display in place of, or in addition to the touch-sensitive display 102.

The mobile device 100 can send and receive communication signals over the wireless network 202 after required network registration or activation procedures have been completed. Network access is associated with a subscriber or user of the mobile device 100. To identify a subscriber, the mobile device 100 may use a subscriber module component or “smart card” 326, such as a Subscriber Identity Module (SIM), a Removable User Identity Module (RUIM) and a Universal Subscriber Identity Module (USIM). In the example shown, a SIM/RUIM/USIM 326 is to be inserted into a SIM/RUIM/USIM interface 328 in order to communicate with a network. Without the component 326, the mobile device 100 is not fully operational for communication with the wireless network 202. Once the SIM/RUIM/USIM 326 is inserted into the SIM/RUIM/USIM interface 328, it is coupled to the main processor 302.

The mobile device 100 is typically a battery-powered device and includes a battery interface 332 for receiving one or more rechargeable batteries 330. In at least some examples, the battery 330 can be a smart battery with an embedded microprocessor. The battery interface 332 is coupled to a regulator (not shown), which assists the battery 330 in providing power to the mobile device 100. Although current technology makes use of a battery, future technologies such as micro fuel cells may provide the power to the mobile device 100.

The mobile device 100 also includes an operating system 334 and software components 336 to 346 which are described in more detail below. The operating system 334 and the software components 336 to 346 that are executed by the main processor 302 are typically stored in a persistent store such as the flash memory 308, which may alternatively be a read-only memory (ROM) or similar storage element (not shown). Those skilled in the art will appreciate that portions of the operating system 334 and the software components 336 to 346, such as specific device applications, or parts thereof, may be temporarily loaded into a volatile store such as the RAM 306. Other software components can also be included, as is well known to those skilled in the art.

The subset of software applications 336 that control basic device operations, including data and voice communication applications, may be installed on the mobile device 100 during its manufacture. Software applications may include a message application 338, a device state module 340, a Personal Information Manager (PIM) 342, a connect module 344 and an IT policy module 346. A message application 338 can be any suitable software program that allows a user of the mobile device 100 to send and receive electronic messages, wherein messages are typically stored in the flash memory 308 of the mobile device 100. A device state module 340 provides persistence, i.e. the device state module 340 ensures that important device data is stored in persistent memory, such as the flash memory 308, so that the data is not lost when the mobile device 100 is turned off or loses power. A PIM 342 includes functionality for organizing and managing data items of interest to the user, such as, but not limited to, e-mail, contacts, calendar events, and voice mails, and may interact with the wireless network 202. A connect module 344 implements the communication protocols that are required for the mobile device 100 to communicate with the wireless infrastructure and any host system, such as an enterprise system, that the mobile device 100 is authorized to interface with. An IT policy module 346 receives IT policy data that encodes the IT policy, and may be responsible for organizing and securing rules such as the “Set Maximum Password Attempts” IT policy.

Other types of software applications or components 339 can also be installed on the mobile device 100. These software applications 339 can be pre-installed applications (i.e. other than message application 338) or third party applications, which are added after the manufacture of the mobile device 100. Examples of third party applications include games, calculators, utilities, etc.

The additional applications 339 can be loaded onto the mobile device 100 through at least one of the wireless network 202, the auxiliary I/O subsystem 312, the data port 314, the short-range communications subsystem 322, or any other suitable device subsystem 324.

The data port 314 can be any suitable port that enables data communication between the mobile device 100 and another computing device. The data port 314 can be a serial or a parallel port. In some instances, the data port 314 can be a USB port that includes data lines for data transfer and a supply line that can provide a charging current to charge the battery 330 of the mobile device 100.

For voice communications, received signals are output to the speaker 318, and signals for transmission are generated by the microphone 320. Although voice or audio signal output is accomplished primarily through the speaker 318, the display 102 can also be used to provide additional information such as the identity of a calling party, duration of a voice call, or other voice call related information.

The touch-sensitive display 102 may be any suitable touch-sensitive display, such as a capacitive, resistive, infrared, surface acoustic wave (SAW) touch-sensitive display, strain gauge, optical imaging, dispersive signal technology, acoustic pulse recognition, and so forth, as known in the art. In the presently described example, the touch-sensitive display 102 is a capacitive touch-sensitive display which includes a capacitive touch-sensitive overlay 364. The overlay 364 may be an assembly of multiple layers in a stack which may include, for example, a substrate, a ground shield layer, a barrier layer, one or more capacitive touch sensor layers separated by a substrate or other barrier, and a cover. The capacitive touch sensor layers may be any suitable material, such as patterned indium tin oxide (ITO).

The display 362 of the touch-sensitive display 102 may include a display area in which information may be displayed, and a non-display area extending around the periphery of the display area. Information is not displayed in the non-display area, which is utilized to accommodate, for example, electronic traces or electrical connections, adhesives or other sealants, and/or protective coatings around the edges of the display area.

One or more touches, also known as touch contacts or touch events, may be detected by the touch-sensitive display 102. The processor 302 may determine attributes of the touch, including a location of a touch. Touch location data may include an area of contact or a single point of contact, such as a point at or near a center of the area of contact, known as the centroid. A signal is provided to the controller 366 in response to detection of a touch. A touch may be detected from any suitable object, such as a finger, thumb, appendage, or other items, for example, a stylus, pen, or other pointer, depending on the nature of the touch-sensitive display 102. The location of the touch moves as the detected object moves during a touch. The controller 366 and/or the processor 302 may detect a touch by any suitable contact member on the touch-sensitive display 102. Similarly, multiple simultaneous touches, are detected.

One or more gestures are also detected by the touch-sensitive display 102. A gesture is a particular type of touch on a touch-sensitive display 102 that begins at an origin point and continues to an end point. A gesture may be identified by attributes of the gesture, including the origin point, the end point, the distance travelled, the duration, the velocity, and the direction, for example. A gesture may be long or short in distance and/or duration. Two points of the gesture may be utilized to determine a direction of the gesture.

An example of a gesture is a swipe (also known as a flick). A swipe has a single direction. The touch-sensitive overlay 364 may evaluate swipes with respect to the origin point at which contact is initially made with the touch-sensitive overlay 364 and the end point at which contact with the touch-sensitive overlay 364 ends rather than using each of location or point of contact over the duration of the gesture to resolve a direction.

Examples of swipes include a horizontal swipe, a vertical swipe, and a diagonal swipe. A horizontal swipe typically comprises an origin point towards the left or right side of the touch-sensitive overlay 364 to initialize the gesture, a horizontal movement of the detected object from the origin point to an end point towards the right or left side of the touch-sensitive overlay 364 while maintaining continuous contact with the touch-sensitive overlay 364, and a breaking of contact with the touch-sensitive overlay 364. Similarly, a vertical swipe typically comprises an origin point towards the top or bottom of the touch-sensitive overlay 364 to initialize the gesture, a horizontal movement of the detected object from the origin point to an end point towards the bottom or top of the touch-sensitive overlay 364 while maintaining continuous contact with the touch-sensitive overlay 364, and a breaking of contact with the touch-sensitive overlay 364.

Swipes can be of various lengths, can be initiated in various places on the touch-sensitive overlay 364, and need not span the full dimension of the touch-sensitive overlay 364. In addition, breaking contact of a swipe can be gradual in that contact with the touch-sensitive overlay 364 is gradually reduced while the swipe is still underway.

Meta-navigation gestures may also be detected by the touch-sensitive overlay 364. A meta-navigation gesture is a gesture that has an origin point that is outside the display area of the touch-sensitive overlay 364 and that moves to a position on the display area of the touch-sensitive display. Other attributes of the gesture may be detected and be utilized to detect the meta-navigation gesture. Meta-navigation gestures may also include multi-touch gestures in which gestures are simultaneous or overlap in time and at least one of the touches has an origin point that is outside the display area and moves to a position on the display area of the touch-sensitive overlay 364. Thus, two fingers may be utilized for meta-navigation gestures. Further, multi-touch meta-navigation gestures may be distinguished from single touch meta-navigation gestures and may provide additional or further functionality. An example of a meta-navigation gesture is the touch-sensitive non-display area gesture 130 of FIG. 1.

In some examples, an optional force sensor 370 or force sensors is disposed in any suitable location, for example, between the touch-sensitive display 102 and a back of the mobile device 100 to detect a force imparted by a touch on the touch-sensitive display 102. The force sensor 370 may be a force-sensitive resistor, strain gauge, piezoelectric or piezoresistive device, pressure sensor, or other suitable device. Force as utilized throughout the specification refers to force measurements, estimates, and/or calculations, such as pressure, deformation, stress, strain, force density, force-area relationships, thrust, torque, and other effects that include force or related quantities.

Force information related to a detected touch may be utilized to select information, such as information associated with a location of a touch. For example, a touch that does not meet a force threshold may highlight a selection option, whereas a touch that meets a force threshold may select or input that selection option. Selection options include, for example, displayed or virtual keys of a keyboard; selection boxes or windows, e.g., “cancel,” “delete,” or “unlock”; function buttons, such as play or stop on a music player; and so forth. Different magnitudes of force may be associated with different functions or input. For example, a lesser force may result in panning, and a higher force may result in zooming.

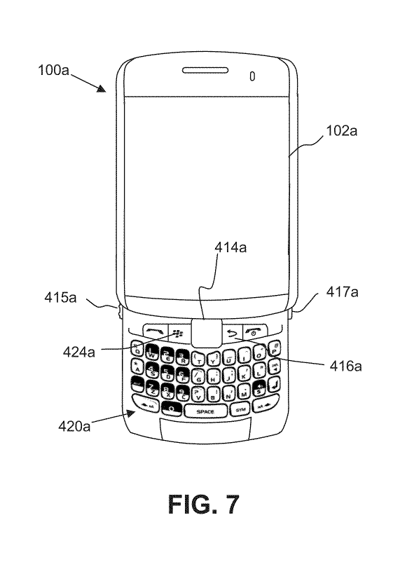

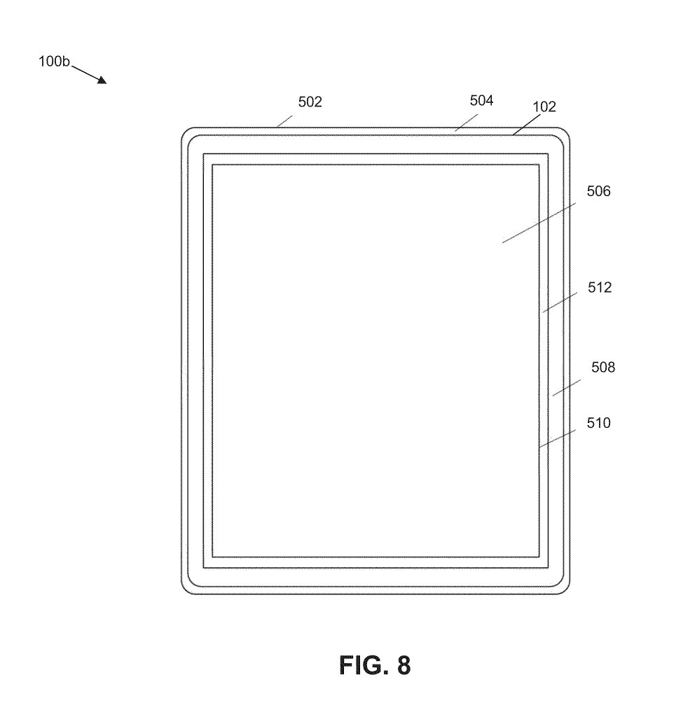

Referring to FIGS. 7 and 8, one example of a mobile device 100a is shown in FIG. 7 and another example of a mobile device 100b is shown in FIG. 8. It will be appreciated that the numeral “100” will hereinafter refer to any mobile device 100, including the examples 100a and 100b, those examples enumerated above or otherwise. It will also be appreciated that a similar numbering convention may be used for other general features common between all figures.

The mobile device 100a shown in FIG. 7 includes a touch-sensitive display area 102a and a cursor or positioning device, which in this example is in the form of a trackpad 414a. In this example, the touch-sensitive display area 102a can span the entire touch-sensitive display 102. The trackpad 414a permits multi-directional positioning of a selection indicator or cursor that can be displayed on the touch-sensitive display area 102a such that the selection cursor can be moved in an upward, downward, left and right direction, and if desired and/or permitted, in any diagonal direction. A selection cursor may include a box, alteration of an icon or any combination of features that enable the user to identify the currently chosen icon or item. The trackpad 414a in this example is situated on the front face of a housing for mobile device 100a to enable a user to maneuver the trackpad 414a while holding the mobile device 100a in one hand. The trackpad 414a may serve as another input member (in addition to a directional or positioning member) to provide selection inputs to a processor of the mobile device and can preferably be pressed in a direction towards the housing of the mobile device 100a to provide such a selection input. It will be appreciated that the trackpad 414a is only one example of a suitable positioning device. For example, a trackball, touch-sensitive display, OLED, or other input mechanism may equally apply.

The mobile device 100a in FIG. 7 also includes a programmable convenience button 415a to activate a selection application such as, for example, a calendar or calculator. Further, mobile device 100a also includes a back button 416a (also known as an escape or cancel button), a camera button 417a, a menu or option button 424a and a keyboard 420a. The camera button 417a is able to activate photo and video capturing functions, e.g. when pressed in a direction towards the housing. The menu or option button 424a can be used to load a menu or list of options on the display 102a when pressed. In this example, the escape or cancel button 416a, the menu option button 424a, and a keyboard 420a are disposed on the front face of the mobile device housing, while the convenience button 415a and camera button 417a are disposed at the side of the housing. This button placement enables a user to operate these buttons while holding the mobile device 100a in one hand. The keyboard 420a is, in this example, a standard QWERTY keyboard, however, it will be appreciated that reduced QWERTY or virtual keyboards (e.g. as provided by a touch-sensitive display) may equally apply.

It will be appreciated that for the mobile device 100, a wide range of one or more positioning or cursor/view positioning mechanisms such as a touch/track pad, a positioning wheel, a joystick button, a mouse, a touch-sensitive display, a set of arrow keys, a tablet, an accelerometer (for sensing orientation and/or movements of the mobile device 100 etc.), OLED, or other whether presently known or unknown may be employed. Similarly, any variation of keyboard 420a may be used. It will also be appreciated that the mobile devices 100 shown in FIGS. 7 and 8 are for illustrative purposes only and various other mobile devices 100 are equally applicable to the following examples. Other buttons may also be disposed on the mobile device housing such as colour coded “Answer” and “Ignore” buttons to be used in telephonic communications.

A front view of an example of the mobile device 100b is shown in FIG. 8. The mobile device 100b includes a housing 502 that encloses components such as shown in FIG. 6. The housing 502 may include a back, sidewalls, and a front 504 that frames the touch-sensitive display 102. The example mobile device 100b shown in FIG. 8 can represent a portable tablet computer or other handheld or otherwise portable device.

In the example of FIG. 8, the touch-sensitive display 102 is generally centered in the housing 502 such that a display area 506 of the touch-sensitive overlay 364 is generally centered with respect to the front 504 of the housing 502. The non-display area 508 of the touch-sensitive overlay 364 extends around the display area 506. In the presently described example, the width of the non-display area is 4 mm. The touch-sensitive display area 122 and the touch-sensitive non-display area 124 of FIG. 1 are examples of a display area 506 of the touch-sensitive overlay 364 and a non-display area 508 of the touch-sensitive overlay 364, respectively.

For the purpose of the present example, the touch-sensitive overlay 364 extends to cover the display area 506 and the non-display area 508. Touches on the display area 506 may be detected and, for example, may be associated with displayed selectable features. Touches on the non-display area 508 may be detected, for example, to detect a meta-navigation gesture. Alternatively, meta-navigation gestures may be determined by both the non-display area 508 and the display area 506. The density of touch sensors may differ from the display area 506 to the non-display area 508. For example, the density of nodes in a mutual capacitive touch-sensitive display, or density of locations at which electrodes of one layer cross over electrodes of another layer, may differ between the display area 506 and the non-display area 508.

Gestures received on the touch-sensitive display 102 may be analyzed based on the attributes to discriminate between meta-navigation gestures and other touches, or non-meta navigation gestures. Meta-navigation gestures may be identified when the gesture crosses over a boundary near a periphery of the display 362, such as a boundary 510 between the display area 506 and the non-display area 508. In the example of FIG. 8, the origin point of a meta-navigation gesture may be determined utilizing the area of the touch-sensitive overlay 364 that covers the non-display area 508.

A buffer region 512 or band that extends around the boundary 510 between the display area 506 and the non-display area 508 may be utilized such that a meta-navigation gesture is identified when a touch has an origin point outside the boundary 510 and the buffer region 512 and crosses through the buffer region 512 and over the boundary 510 to a point inside the boundary 510. Although illustrated in FIG. 8, the buffer region 512 may not be visible. Instead, the buffer region 512 may be a region around the boundary 510 that extends a width that is equivalent to a predetermined number of pixels, for example. Alternatively, the boundary 510 may extend a predetermined number of touch sensors or may extend a predetermined distance from the display area 506. The boundary 510 may be a touch-sensitive region or may be a region in which touches are not detected.

Gestures that have an origin point in the buffer region 512, for example, may be identified as non-meta navigation gestures. Optionally, data from such gestures may be utilized by an application as a non-meta navigation gesture. Alternatively, data from such gestures may be discarded such that touches that have an origin point on the buffer region 512 are not utilized as input at the mobile device 100.

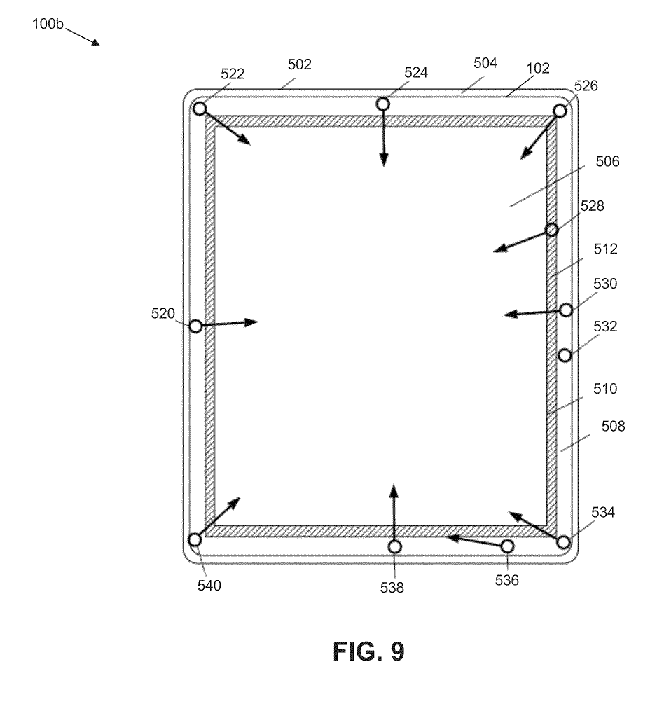

FIG. 9 illustrates examples of touches on the touch-sensitive display 102. The buffer region 512 is illustrated in FIG. 9 by hash markings for the purpose of explanation. As indicated, the buffer region 512 may not be visible to the user. For the purpose of explanation, touches are illustrated by circles at their points of origin. Arrows extending from the circles illustrate the paths of the touches that are gestures.

The touch 538 begins at the origin point outside the boundary 510 and outside the buffer region 512. The path of the touch 538 crosses the buffer region 512 and the boundary 510 and is therefore identified as a meta-navigation gesture. Similarly, the touches 520, 530, 524, 522, 526, 540, 534 each have origin points outside the boundary 510 and the buffer region 512 and their paths cross the buffer region 512 and the boundary 510. Each of the touches 520, 530, 524, 522, 526, 540, 534 is therefore identified as a meta-navigation gesture. The touch 528, however, has an origin point that falls within the buffer region 512 and the touch 528 is therefore not identified as a meta-navigation gesture. The touch 536 begins at an origin point outside the boundary 510 and the buffer region 512. The path of the touch 536, however, does not cross the boundary 510 and is therefore not identified as a meta-navigation gesture. The touch 532 also has an origin point outside the boundary 510 and the buffer region 512 but is not a gesture and therefore does not cross the boundary 510 and is not identified as a meta-navigation gesture.

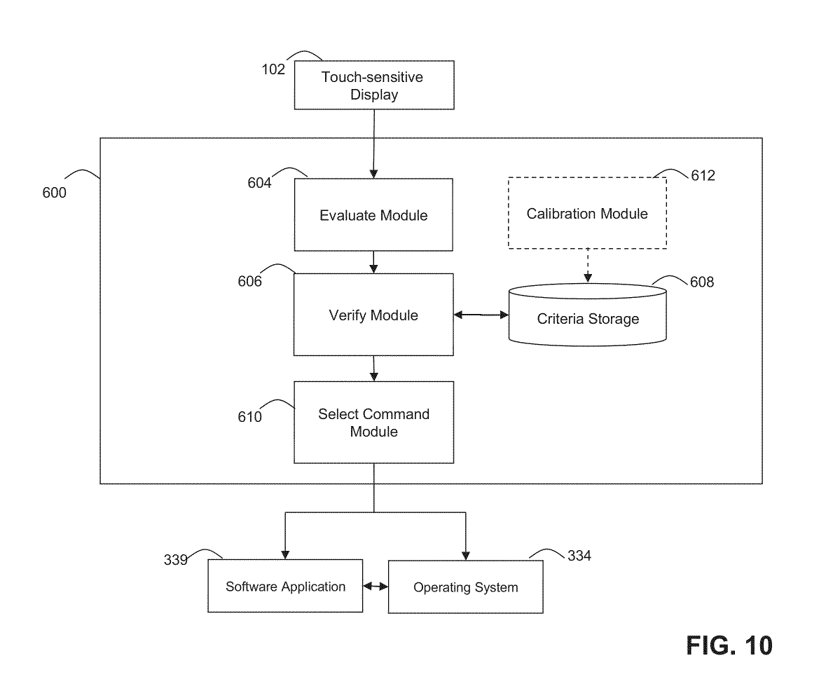

Referring to FIG. 10, an example of a configuration for gesture input application 600 is provided. The gesture input application 600 can be one of the other software applications 339 of FIG. 6 that can be loaded on the mobile device 100 or an input method service of the operating system 334 used by other software applications 339. The gesture input application 600 can request details of activity occurring in, or receive inputs from, a component that can receive gestures 130, such as a touch-sensitive display 102 for example. It will be appreciated that other touch-sensitive input mechanisms can be used in replacement of, or in addition to the touch-sensitive display 102 to provide gestures 130 to the gesture input application 600. The gesture input application 600 can also send a back command to the operating system 334 or other software applications 339.

The gesture input application 600 in the example of FIG. 10 includes an evaluate module 604 for receiving a gesture 130 performed on the touch-sensitive display 102 and for evaluating one or more properties of the gesture 130. The gesture input application 600 includes a verify module 606 for verifying that one or more properties of the gesture 130 meet predetermined criteria, including whether the gesture 130 is a back gesture, and a criteria storage 608 for storing the predetermined criteria. The gesture input application 600 also includes a select command module 610 for associating the gesture 130 with a back command and sending the back command to a program if the gesture 130 meets the predetermined criteria.

The evaluate gesture module 604 receives a gesture 130 from the touch-sensitive display 102 and determines various properties associated with the gesture 130 such as its origin point, end point, path, duration, orientation, pressure, etc. In an example, the angle θ of a diagonal gesture can also be calculated based on the origin point and end point.

The verify module 606 receives information on a gesture 130 and uses the information to determine whether one or more criterion are met by the gesture 130. For example, the origin point and end point, as determined the evaluate gesture module 604, can be compared to determine whether the origin point is left or right of the end point, and thus determine whether the gesture 130 is a back gesture. The origin and end point can also be compared to determine whether the origin point is above or below the end point, and when taking in combination with whether the origin point is left or right of the end point, can determine whether the gesture is a diagonal gesture and the direction thereof. In another example, the angle θ of a diagonal gesture, as calculated by the evaluate module 604, can be compared to an acceptable range of angles. In the example of FIG. 10, the verify module 606 can retrieve criteria used to verify the gesture 130 from the criteria storage 608.

If the gesture meets the predetermined criteria, and thus is considered a back gesture, the select command module 610 can select a back command, and associate the back command with the gesture 130. The select command module 610 can then send the back command associated with the gesture 130 to a program, such as the operating system 334 or other software application 339, running on the mobile device 100. In an example, the select command module 610 can send a back command to the active application running on the mobile device 100. In another embodiment, where multiple application windows are being displayed on the touch-sensitive display 102, a point on the path of the gesture 130, such as the origin point, can select the particular software application 339 displayed at that location on the touch-sensitive display 102 to be sent the back command.

The back command may correspond to one or more instructions to cause the mobile device 100 to perform actions typically associated with a back button, cancel button and/or escape button, such as closing a software application 339, returning to a previous view displayed on the mobile device 100, or cancelling an operation being performed on the mobile device 100. The format of the instructions may be determined by the application programming interface of the subsystem or application responsible for executing the instructions.

In an example embodiment, the criteria storage 608 can obtain one or more criterion from a calibration module 612. The calibration module 612 may run a calibration routine on the mobile device 100 to create criteria tailored to a particular user. A calibration routine may prompt the user to perform different types of gestures to determine properties that distinguish the gesture types as performed by that user. The calibration routine may also prompt a user to perform the same type of gesture repeatedly to determine the range of values for a specific property that still indentifies the same type of gesture.

It will be appreciated that the gesture 130 of FIG. 1 performed by the thumb 142 may tend to produce a different angle θ for different users as the anatomy of a user's hand may vary between individuals. Furthermore, the angle θ may vary depending on the manner in which a user holds the mobile device 100 or the technique used in performing the gesture 130. It will further be appreciated that the gesture 130 may be performed by other objects, such as the index finger of a user (left or right hand), and that the mobile device 100 can be held in a variety of different manners (e.g. with the hand not performing the gesture). Furthermore, the mobile device 100 may be supported without the aid of the user, such as placing the mobile device 100 on a surface or stand. Therefore, the calibration routine may enable the mobile device 100 to recognize and distinguish gestures performed by a particular user on a mobile device 100 more effectively.

It will be appreciated that any module, subsystem component exemplified herein that executes instructions or operations may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data, except transitory propagating signals per se. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the mobile device 100 or accessible or connectable thereto. Any application or module herein described may be implemented using computer readable/executable instructions or operations that may be stored or otherwise held by such computer readable media.

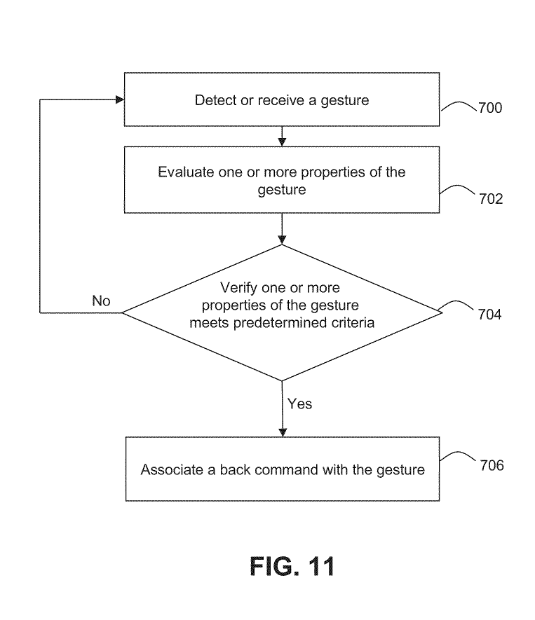

Referring to FIG. 11, an example set of computer executable instructions is provided for controlling a electronic device, such as a mobile device 100. At block 700, a gesture 130 is received on or detected by a touch-sensitive input mechanism of the mobile device 100. At block 702, one or more properties of the gesture 130 is determined. At block 704, one or more properties of the gesture 130 is verified to meet predetermined criteria, including the criterion that the gesture 130 is a back gesture. If the predetermined criteria is met, at block 706, a back command is associated with the gesture 130.

As noted above, at block 700, a gesture 130 is received or detected from a touch-sensitive input mechanism. In an example configuration of the gesture input application 600, the touch-sensitive display 102 or a touch pad (not shown) may implement block 700 (FIG. 10).

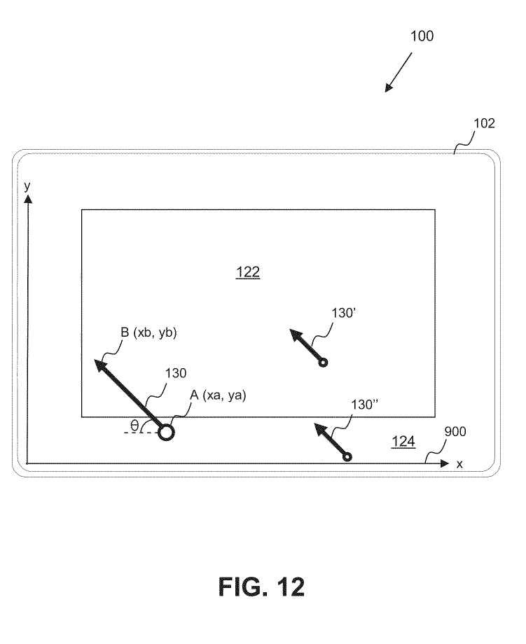

At block 702, one or more properties of the gesture 130 is determined such as the gesture's origin point, end point, path, duration, orientation, pressure, etc. In an example configuration of the gesture input application 600, the evaluate module 604 may implement block 702 (FIG. 10). In one example, the surface of the touch-sensitive display 102 may be mapped to a co-ordinate system, such as the x-y coordinate system 900 of FIG. 12. The origin point, end point, and one or more intermediate points along the path of the gesture can be represented by (x,y) co-ordinates. Additional properties of the gesture can then be calculated using such co-ordinates. For example, the gesture 130 of FIG. 12 has an origin point A=(xa, ya) and an end point B=(xb, yb). The evaluate module 604 can calculate the difference in the x and y co-ordinates to determine the orientation of the gesture 130. The evaluate module 604 can determine that the gesture 130 moves in an upward/left diagonally direction by determining that xa−xb>0 and ya−yb<0. In another example, the angle θ of the gesture 130 can be calculated using trigonometry (e.g. θ=arctangent{(|xb−xa|)/(|yb−ya|)}). It will be appreciated that a variety of properties of the gesture 130 can be determined.

At block 704, one or more properties of the gesture 130 can be verified to meet predetermined criteria. In the example configuration of the gesture input application 600, the verify module 606 may implement block 704 to verify that one or more properties determined by the evaluate module 604 meet predetermined criteria (FIG. 10).

In one example, the criteria may be based on the orientation, shape and/or type of the gesture. For example, the criteria may be that the gesture 130 must be a back gesture swiping in an upward/left diagonal direction. The verify module 606 may perform the verification by determining whether: i) xa−xb>0 (i.e. back gesture), ii) xa−xb>0 and ya−yb<0 (i.e. upward/left diagonal direction) and iii) adjacent points along the path of the gesture 130 have a similar slope (e.g. within ±10% to indicate the gesture 130 is a swipe in a substantially straight line). The criteria may also include that the angle θ may need to be within a predetermined range (e.g. 35° to 55°) so as to clearly be distinguished from a horizontal or vertical swipe gesture, which may be associated with a command other than the back command.

In another example, the criteria may be based on the location of the gesture 130. For example, the touch-sensitive display 102 may include a touch-sensitive display area 122 and a touch-sensitive non-display area 124. A mobile device 100 may differentiate a gesture 130″ contained within the touch-sensitive non-display area 124 from a gesture 130′ contained within the touch-sensitive display area 122, and also from the gesture 130 involving both the touch-sensitive display area 122 and touch-sensitive non-display area 124.

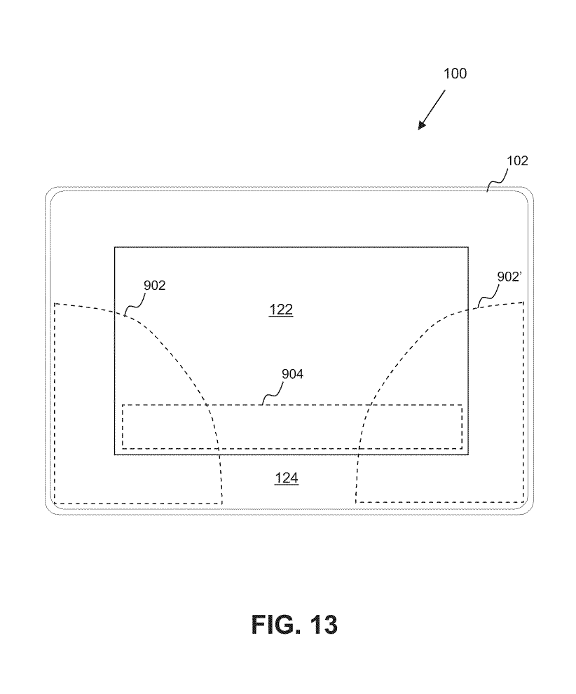

In another example, the gesture input application 600 can associate a back command with back gestures that are only contained within one or more specific areas of the touch-sensitive display 102, such as the touch-sensitive non-display area 124 (e.g. gesture 130″). It will be appreciated that the gesture input application 600 can define any area of the touch-sensitive display 102 to receive gestures that can be associated with a back command. For example, gestures that can be associated with a back command may be limited to gestures performed on regions 902 and 902′, which may be areas that frequently receive gestures (FIG. 13). In another example, a back command may only be inputted by performing a gesture in a region 904, which may be used to display a toolbar or virtual touch pad. Limiting the area of the touch-sensitive display 102 able to receive gestures to be associated with a back command may minimize the likelihood of inadvertently inputting a back command by performing an accidental gesture on other areas the mobile device 100.

Limiting the area of the touch-sensitive display 102 able to receive gestures to be associated with a back command may also free up that type of gesture for association with a different command when performed elsewhere on the touch-sensitive display 102. For example, the gesture 130″ on the touch-sensitive non-display area 124 may be used to input a back command but the gesture 130′ may be used to pan content displayed on the touch-sensitive display area 122.

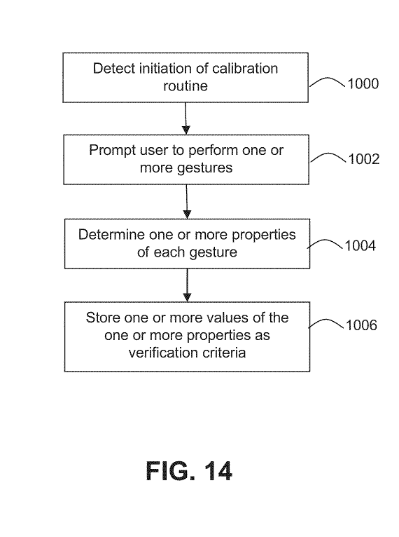

As noted above, in an example embodiment, one or more criterion may be provided from a calibration module 612. The calibration module 612 may run a calibration routine on the mobile device 100 to create a particular set of criteria tailored to a particular user. FIG. 14 illustrates an example set of computer executable instructions for implementing an example calibration routine.

At block 1000, the calibration module 612 detects initiation of the calibration routine. For example, the mobile device 100 may perform calibration at start up, at the time a new user profile is created, at the request of a user by selecting a menu option or at the request of an application (e.g. based on quality factors or other criteria).

At block 1002, the calibration module 612 enables a prompt to be displayed that instructs the user to perform one or more gestures at various orientations and directions. The calibration routine may step through a series of prompts asking the user to perform horizontal, vertical and diagonal swipe gestures in each direction. Any number of gestures and gesture types can be used. For example, the calibration routine may prompt the user to perform an upward/left diagonal swipe gesture at an angle θ of 45°.

At block 1004, one or more properties of a gesture performed by the user can be determined. For example, in response to prompting the user to perform an upward/left diagonal swipe gesture at an angle θ of 45°, the calibration routine can determine the actual angle θ of the gesture performed.

At block 1006, one or more values of the one or more properties determined by the calibration routine may be stored in the criteria storage 608 for use as a verification criterion by the verify module 606. For example, if the user performs an upward/left diagonal swipe gesture at an angle θ in the range of 20° to 60° when prompted to perform an upward/left diagonal swipe gesture at an angle θ of 45°, the mobile device 100 may set the gesture input application 600 to recognize all upward/left diagonal swipe gestures at an angle θ in the range of 20° to 60° and to associate a back command with such gestures. It will be appreciated that the calibration routine can also provide criteria values for other properties of a gesture 130, such as speed, length, curvature, etc.

Referring back to FIG. 11, at block 706, a back command is associated with the gesture 130 if the gesture 130 meets the predetermined criteria. In an example configuration of the gesture input application 600, the select command module 610 may implement block 700 (FIG. 10). The back command can then be sent to a program on the mobile device 100 for execution.

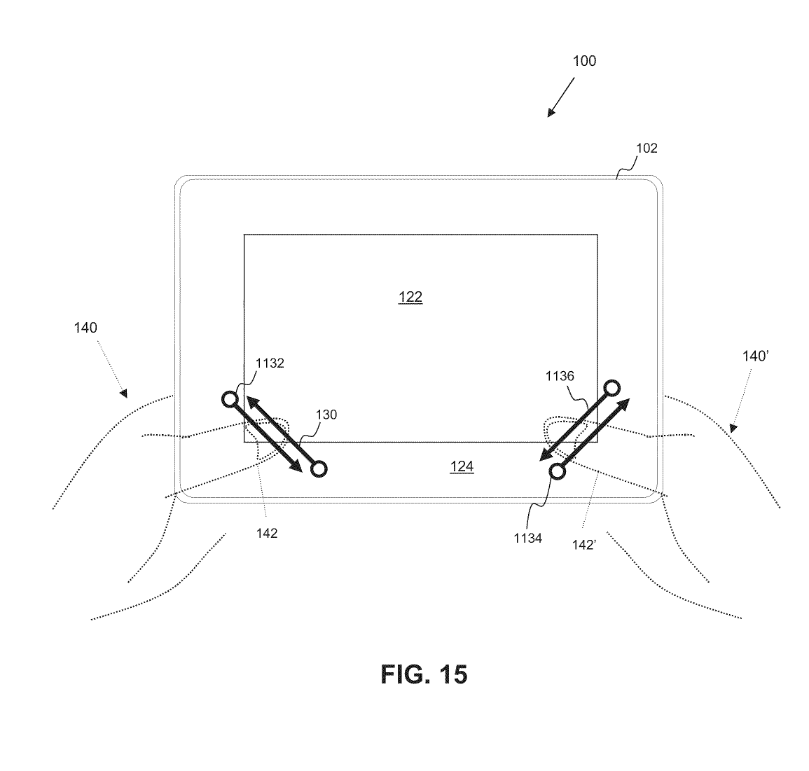

It will be appreciated that the gesture 130 comprising an upward/left diagonal swipe gesture is an example of a gesture 130 that can be associated with a back command. Other gestures that incorporate movement from right to left may be used such as a downward/left diagonal swipe gesture 1136 (FIG. 15) or a horizontal swipe in the left direction (not shown). The gesture 1136 may be performed by following the natural motion of the thumb 142′ of the right hand 140′ of a user (shown in dotted lines).

It will further be appreciated that the principles described herein are equally applicable to associating a forward command with a gesture incorporating movement from left to right. For example, a forward command can be associated with a downward/right diagonal swipe gesture 1132, a upward/right diagonal swipe gesture 1134 (FIG. 15) or a horizontal swipe in the right direction (not shown). Gestures 1132 and 1134 may be suitable for a forward command as the gestures involve movement from left to right, which may typically be associated with the notion of “forward”.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the spirit of the invention or inventions. For instance, the steps may be performed in a differing order, or steps may be added, deleted, or modified.

Although the above has been described with reference to certain specific examples, various modifications thereof will be apparent to those skilled in the art as outlined in the appended claims.

1. A method of controlling an electronic device comprising:
detecting a gesture on a touch-sensitive input mechanism of the electronic device, the gesture comprising an origin point and an end point; and
executing a command associated with the gesture, the command comprising a back command if the end point is located left of the origin point with respect to an orientation of the electronic device or comprising a forward command if the end point is located right of the origin point with respect to the orientation of the electronic device;
wherein a dedicated non-gesture input mechanism to input the command is absent from the electronic device.

2. The method of claim 1, wherein a program executing the command was developed for a different platform than a platform of the electronic device, the different platform comprising the input mechanism absent from the electronic device.

3. The method of claim 2, wherein the input mechanism absent from the electronic device comprises any one or more of a physical button and a virtual on screen button.

4. The method of claim 1, wherein the gesture comprises a swipe in a substantially diagonal direction with respect to an orientation of the electronic device.

5. The method of claim 4, wherein the command is executed in association with the gesture if the gesture is within a predetermined range of angles with respect to an axis of the electronic device.

6. The method of claim 1, wherein the gesture is contained within one or more specific areas of the touch-sensitive input mechanism.

7. The method of claim 1, wherein the location of the origin point of the gesture determines an application to receive the command.

8. The method of claim 1, wherein the command is associated with only a set of gestures satisfying one or more predetermined criteria.

9. The method of claim 1, wherein the back command corresponds to any one or more of: closing a current application of the electronic device, returning to a previous view displayed on the electronic device and cancelling an operation of the electronic device.

10. A computer readable storage medium for controlling an electronic device, the computer readable storage medium comprising computer executable instructions for:
detecting a gesture on a touch-sensitive input mechanism of the electronic device, the gesture comprising an origin point and an end point; and
executing a command associated with the gesture, the command comprising a back command if the end point is located left of the origin point with respect to an orientation of the electronic device or comprising a forward command if the end point is located right of the origin point with respect to the orientation of the electronic device;
wherein a dedicated non-gesture input mechanism to input the command is absent from the electronic device.

11. The computer readable storage medium of claim 10, wherein a program executing the command was developed for a different platform than a platform of the electronic device, the different platform comprising the input mechanism absent from the electronic device.

12. The computer readable storage medium of claim 11, wherein the input mechanism absent from the electronic device comprises any one or more of a physical button and a virtual on screen button.

13. The computer readable storage medium of claim 10, wherein the gesture comprises a swipe in a substantially diagonal direction with respect to an orientation of the electronic device.

14. The computer readable storage medium of claim 13, wherein the command is executed in association with the gesture if the gesture is within a predetermined range of angles with respect to an axis of the electronic device.

15. The computer readable storage medium of claim 10, wherein the gesture is contained within one or more specific areas of the touch-sensitive input mechanism.

16. An electronic device comprising a processor, a touch-sensitive input mechanism and memory, the memory storing computer executable instructions for:
detecting a gesture on the touch-sensitive input mechanism, the gesture comprising an origin point and an end point; and
executing a command associated with the gesture, the command comprising a back command if the end point is located left of the origin point with respect to an orientation of the electronic device or comprising a forward command if the end point is located right of the origin point with respect to the orientation of the electronic device;
wherein a dedicated non-gesture input mechanism to input the command is absent from the electronic device.

17. The electronic device of claim 16, wherein a program executing the command was developed for a different platform than a platform of the electronic device, the different platform comprising the input mechanism absent from the electronic device.

18. The electronic device of claim 17, wherein the input mechanism absent from the electronic device comprises any one or more of a physical button and a virtual on screen button.

19. The electronic device of claim 16, wherein the gesture comprises a swipe in a substantially diagonal direction with respect to an orientation of the electronic device.

20. The electronic device of claim 19, wherein the command is executed in association with the gesture if the gesture is within a predetermined range of angles with respect to an axis of the electronic device.
